(19) United States
(12) Patent Application Publication
(10) Pub. No.: US 2012/0110026 A1
(43) Pub. Date: May 3, 2012

(54) DATA TABLES ACCESSIBLE BY TWO SCRIPTS

(75) Inventors: J. Mark Brassil, Anoka, MN (US); John C. Horton, St. Paul, MN (US); Michael J. Hill, Vadnais Heights, MN (US)

(73) Assignee: Unisys Corp., Blue Bell, PA (US)

(21) Appl. No.: 12/913,874

(22) Filed: Oct. 28, 2010

(51) Int. Cl. G06F 17/30

(52) U.S. Cl. 707/801; 707/791; 707/E17.011

(57) ABSTRACT

A table may be stored in a data structure and accessed by two scripts from different platforms. For example, a table of inputs from a web form may be stored with a first script for execution on a first platform. The table may be accessible to the first script when executing on the first platform and accessible to a second script when executing on a second platform. According to one embodiment, the first script may be a business information server (BIS) script and the second script may be a JavaScript. The dual compatibility table allows the web form inputs to be accessed by multiple scripts having different requirements.

### TECHNICAL FIELD

The instant disclosure relates to computer programs. More specifically, the disclosure relates to tables for storing data accessible by computer programs.

### BACKGROUND

Data input collected by a web form may be inaccessible to scripts that do not understand the data format of the input data. For example, the web form may produce a data format unrecognizable to scripts such as JavaScripts. Although software products may be available to convert the data input to a data format compatible with other scripts, the conversion process consumes processor time and may result in two copies of the data stored in memory. Thus, it would be desirable to store the data from the web form in a format accessible by scripts of different languages and/or platforms (e.g., instances of a language running on an instance of a processing engine).

### SUMMARY

According to one embodiment, a data structure embodied on a computer readable medium includes a first script executable by a first platform. The data structure also includes a table having at least one pair of a name and a value. The table may be consumable by the first script and by a second script executable by a second platform.

According to another embodiment, a method includes obtaining input from a web browser. The method also includes storing the input in a table accessible by a first script of a first platform and a second script of a second platform. The method further includes reading the table by the second script of the second platform.

According to yet another embodiment, an apparatus includes a processor coupled to a memory, in which the processor is configured to obtain input from a web browser. The processor is further configured to store the input in a table accessible by a first script of a first platform and a second script of a second platform. The processor is also configured to read the table by the second script of the second platform.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a system for collecting and/or storing input from a web form according to one embodiment of the disclosure.

FIG. 2 is block diagram illustrating a data management system configured to store input from a web form according to one embodiment of the disclosure.

FIG. 3 is a block diagram illustrating a computer system for collecting and/or storing input from a web form according to one embodiment of the disclosure.

FIG. 4 is a block diagram illustrating an exemplary data structure for storing a table according to one embodiment of the disclosure.

FIGS. 5A-5B are a computer program product illustrating an exemplary table according to one embodiment of the disclosure.

FIGS. 6A-6E are a computer program product illustrating an exemplary table according to another embodiment of the disclosure.

FIG. 7 is a flow chart illustrating a method for processing user input from a web page according to one embodiment of the disclosure.

### DETAILED DESCRIPTION

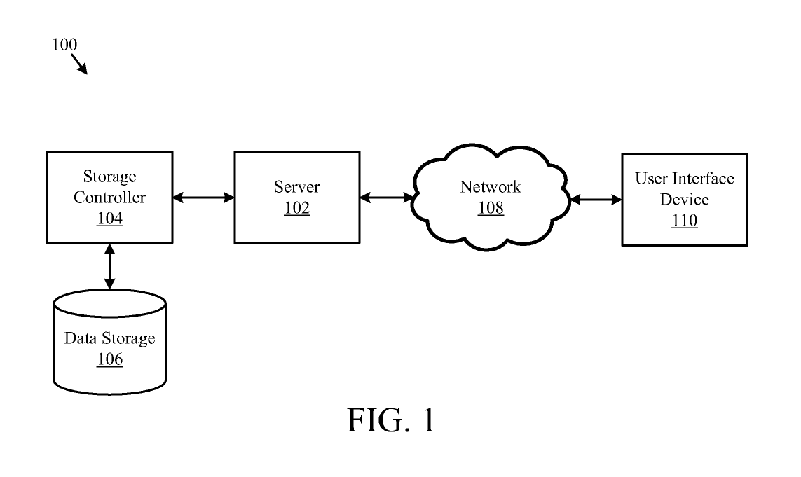

FIG. 1 illustrates one embodiment of a system 100. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108.

In one embodiment, the user interface device 110 is referred to broadly and is intended to encompass a suitable processor-based device such as a desktop computer, a laptop computer, a personal digital assistant (PDA) or table computer, a smartphone or other a mobile communication device or organizer device having access to the network 108. In a further embodiment, the user interface device 110 may access the Internet or other wide area or local area network to access a web application or web service hosted by the server 102 and provide a user interface for enabling a user to enter or receive information.

The network 108 may facilitate communications of data between the server 102 and the user interface device 110. The network 108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

Additionally, the server may access data stored in the data storage device 106 via a Storage Area Network (SAN) connection, a LAN, a data bus, or the like. The data storage device 106 may include a hard disk, including hard disks arranged in an Redundant Array of Independent Disks (RAID) array, a tape storage drive comprising a magnetic tape data storage device, an optical storage device, or the like. In one embodiment, the data storage device 106 may store input from a web form. The data may be arranged in a database and accessible through Structured Query Language (SQL) queries, or other data base query languages or operations.

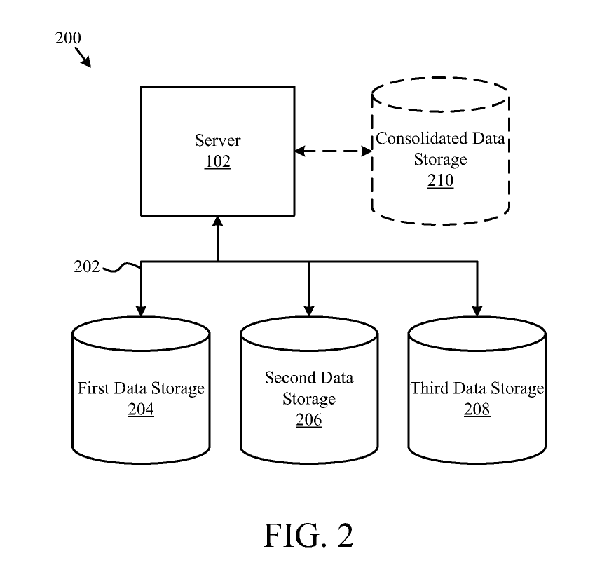

FIG. 2 illustrates one embodiment of a data management system 200 configured to store web browser input. In one embodiment, the data management system 200 may include a server 102. The server 102 may be coupled to a data-bus 202. In one embodiment, the data management system 200 may also include a first data storage device 204, a second data storage device 206, and/or a third data storage device 208. In further embodiments, the data management system 200 may include additional data storage devices (not shown). In such an embodiment, each data storage device 204, 206, 208 may each host a separate database that may, in conjunction with the other databases, contain redundant data. Alternatively, the storage devices 204, 206, 208 may be arranged in a RAID configuration for storing a database or databases through may contain redundant data.

The server 102 may store the consolidated data set in a consolidated data storage device 210. In such an embodiment, the server 102 may refer back to the consolidated data storage device 210 to obtain a set of data elements. Alternatively, the server 102 may query each of the data storage devices 204, 206, 208 independently or in a distributed query to obtain the set of data elements. In another alternative embodiment, multiple databases may be stored on a single consolidated data storage device 210.

The data management system 200 may also include files for entering and processing input data from a web form. In various embodiments, the server 102 may communicate with the data storage devices 204, 206, 208 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), Serial Advanced Technology Attachment (SATA), Advanced Technology Attachment (ATA), and/or other similar data communication schemes associated with data storage and communication. For example, the server 102 may communicate indirectly with the data storage devices 204, 206, 208, 210; the server 102 first communicating with a storage server or the storage controller 104.

The server 102 may host a software application including modules for interfacing with the data storage devices 204, 206, 208, 210, interfacing a network 108, interfacing with a user through the user interface device 110, and the like. In a further embodiment, the server 102 may host an engine, application plug-in, or application programming interface (API).

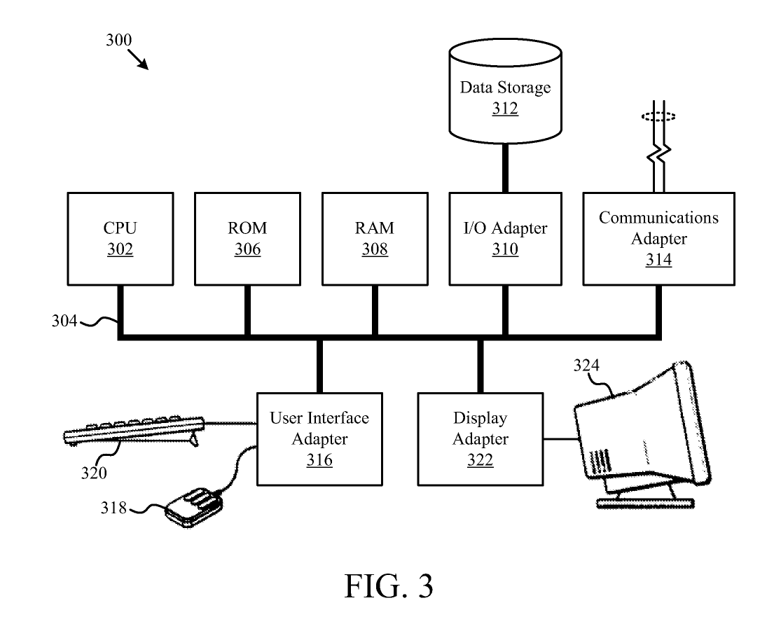

FIG. 3 illustrates a computer system 300 adapted according to certain embodiments of the server 102 and/or the user interface device 110. The central processing unit (“CPU”) 302 is coupled to the system bus 304. The CPU 302 may be a general purpose CPU or microprocessor, graphics processing unit (“GPU”), microcontroller, or the like. The present embodiments are not restricted by the architecture of the CPU 302 so long as the CPU 302, whether directly or indirectly, supports the modules and operations as described herein. The CPU 302 may execute the various logical instructions according to the present embodiments.

The computer system 300 also may include random access memory (RAM) 308, which may be SRAM, DRAM, SDRAM, or the like. The computer system 300 may utilize RAM 308 to store the various data structures used by a software application having code to enroll individuals in an identification system. The computer system 300 may also include read only memory (ROM) 306 which may be PROM, EPROM, EEPROM, optical storage, or the like. The ROM may store configuration information for booting the computer system 300. The RAM 308 and the ROM 306 hold user and system data.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300. In a further embodiment, the display adapter 322 may display a graphical user interface associated with a software or web-based application.

The I/O adapter 310 may connect one or more storage devices 312, such as one or more of a hard drive, a compact disk (CD) drive, a floppy disk drive, and a tape drive, to the computer system 300. The communications adapter 314 may be adapted to couple the computer system 300 to the network 108, which may be one or more of a LAN, WAN, and/or the Internet. The user interface adapter 316 couples user input devices, such as a keyboard 320 and a pointing device 318, to the computer system 300. The display adapter 322 may be driven by the CPU 302 to control the display on the display device 324.

The applications of the present disclosure are not limited to the architecture of computer system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

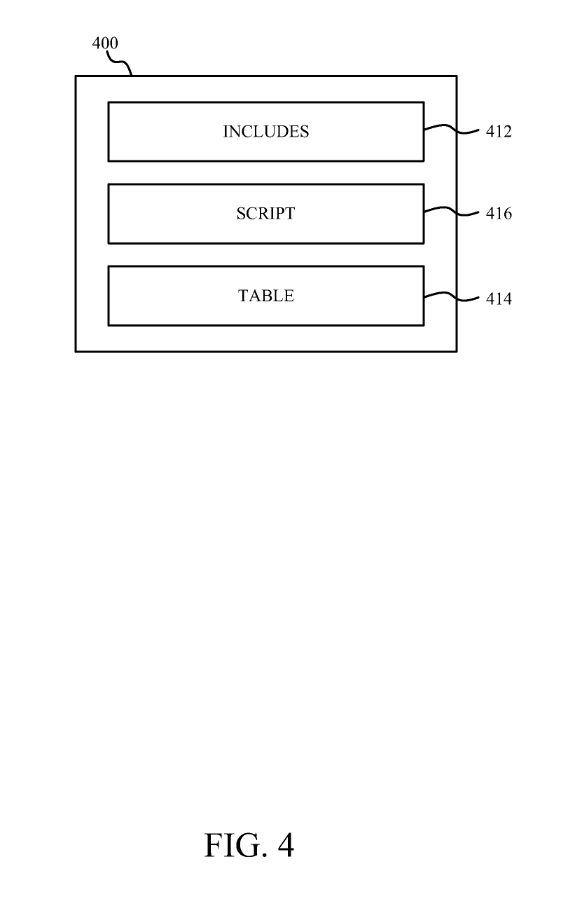

FIG. 4 is a block diagram illustrating an exemplary data structure for storing a table according to one embodiment of the disclosure. A data structure 400 includes a table 414, a script 416, and includes 412. The table 414 may include pairs of names and values associated with the names. According to one embodiment, the data of the table 414 may be obtained through web forms.

The script 416 may be a script for execution by an information server (IS) and/or business information server (BIS). Although the data of the table 414 is attached to the script 416, the data of the table 414 may be made available to scripts on other platforms. For example, the data of the table 414 may be compatible with JavaScript or other languages. According to one embodiment, the data in the table 414 is converted to JavaScript arrays through a JavaScript subroutine included by an include statement 412 incorporating the subroutine. Thus, the table 414 of the data structure 400 is accessible by multiple scripts operating on different platforms.

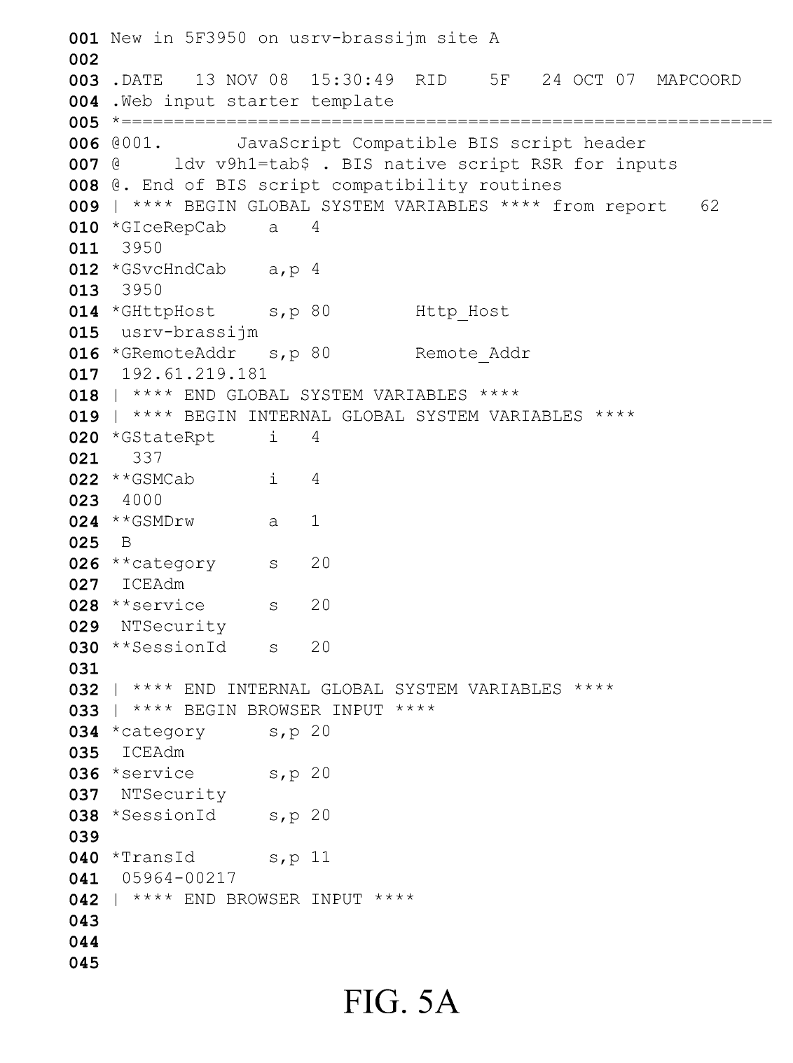

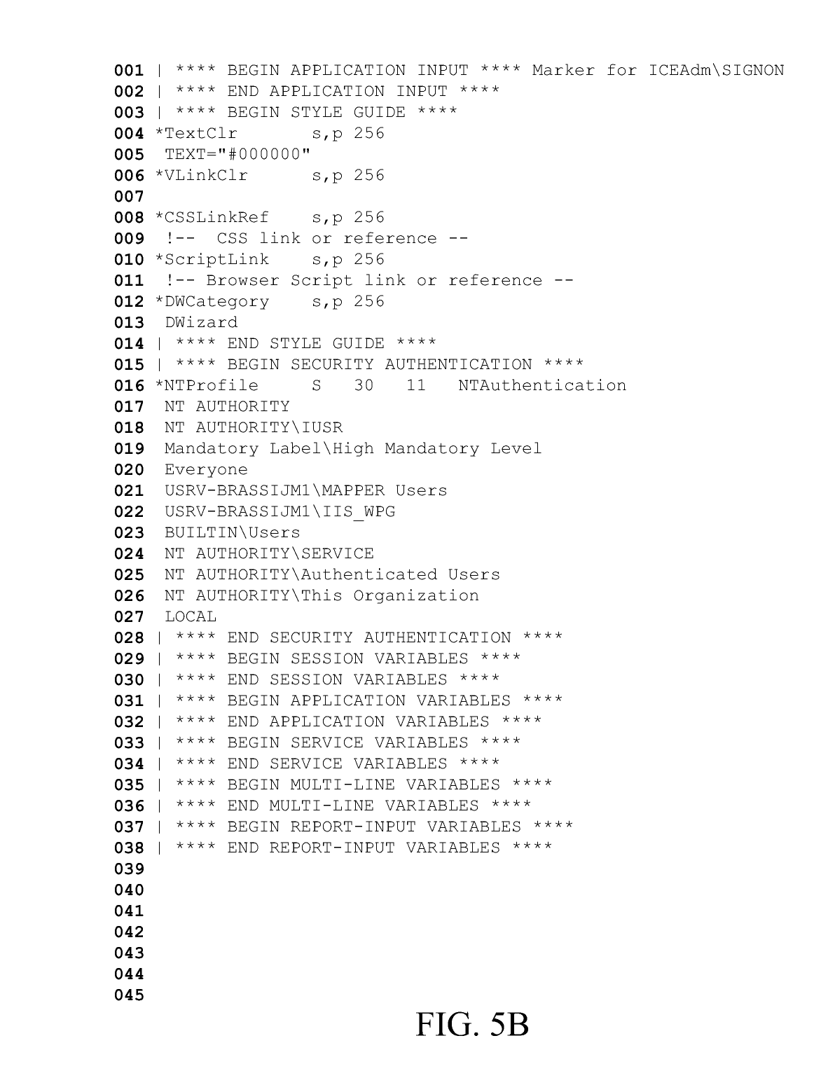

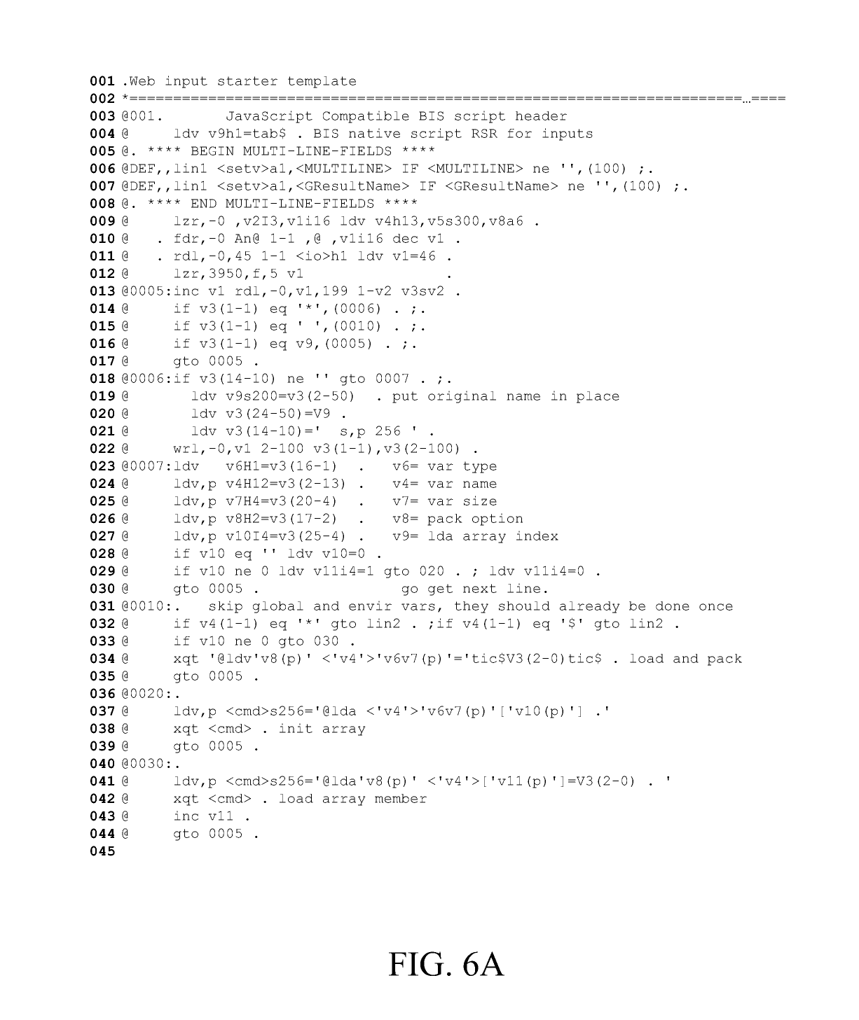

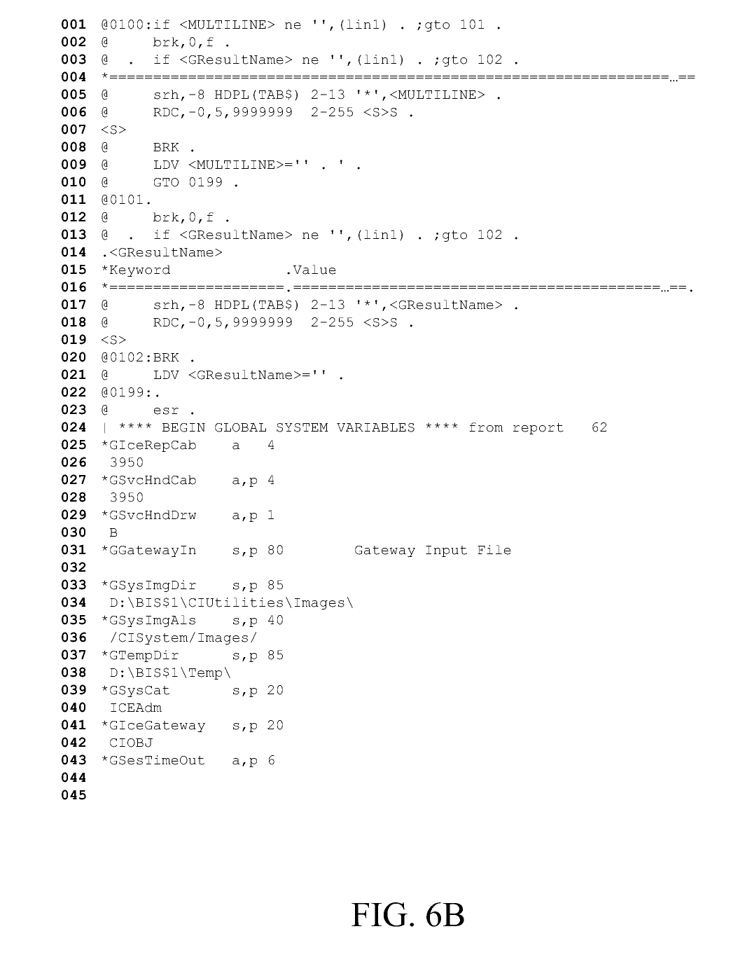

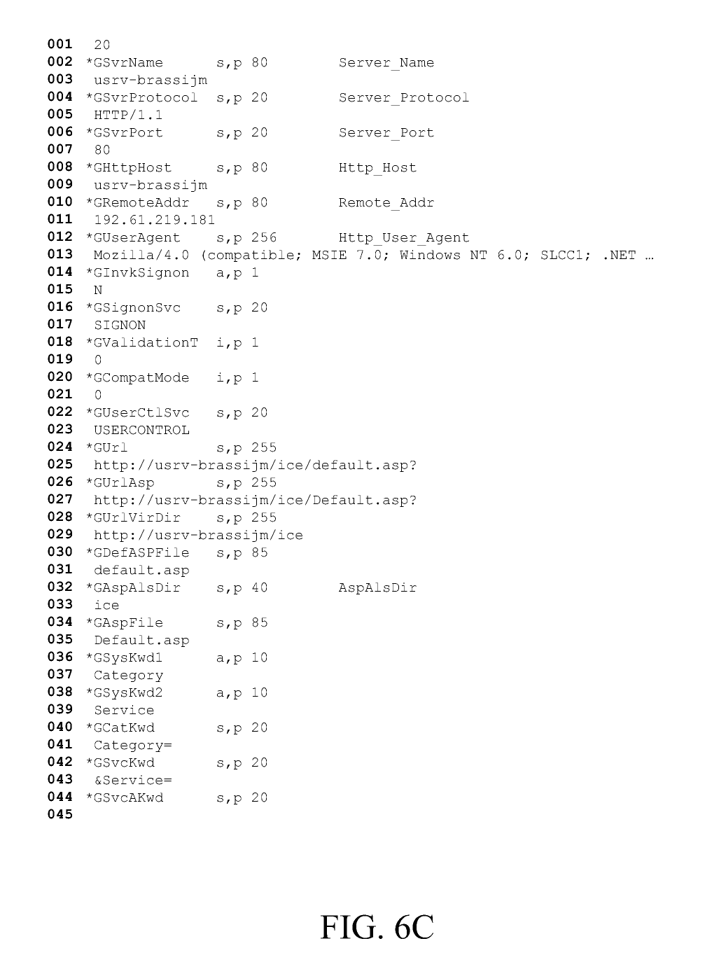

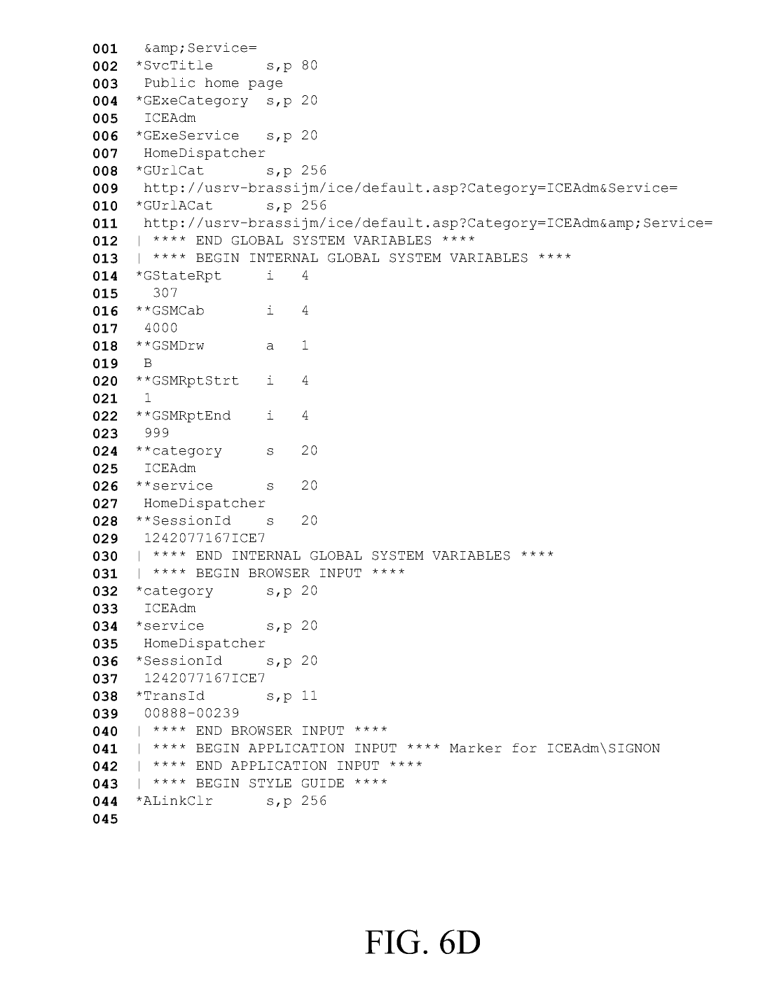

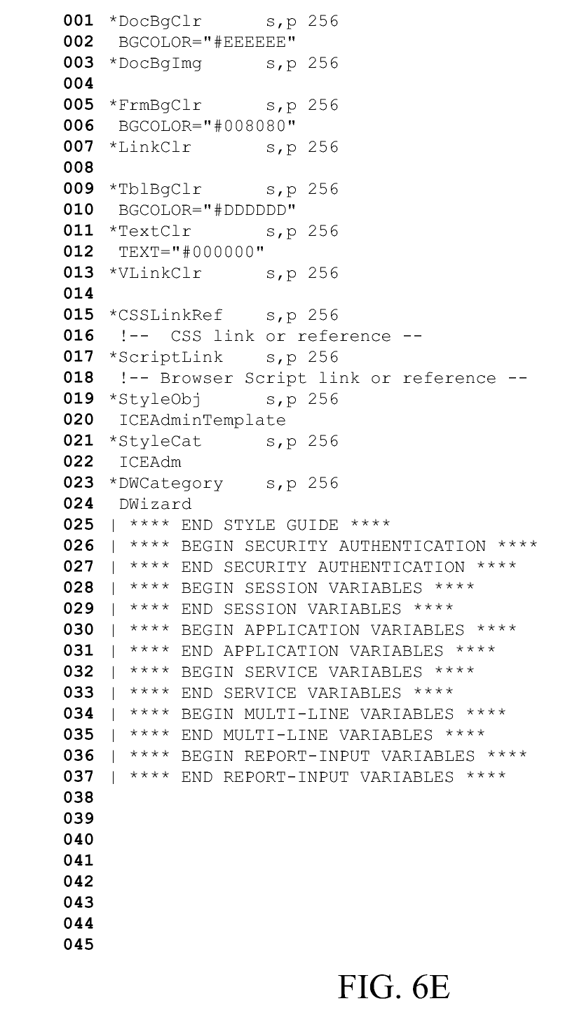

FIGS. 5A-5B are a computer program product illustrating an exemplary table according to one embodiment of the disclosure. A table begins at line 010 of FIG. 5A and continues to line 038 of FIG. 5B. The table includes a number of name and value pairs organized in tab lines. The values of the table are organized in asterisk lines to identify variable description information. The value is followed by one or more space line types containing variable content in columns 2 to the end of the column. The variable description information may include the variable name characters (2-13, 12 plus leading * or $), variable type (16-1) packing option (17-2) and variable size (20-4), array size (25-4), and/or the original full name from the web input if present (at column 30). In the code shown in FIGS. 5A-5B and 6A-6E a vertical pipe (“|”) denotes a tab character.

According to one embodiment, the computer program product includes a compatibility statement. For example, line 006 of FIG. 5A includes a compatibility statement indicating the computer program product of FIGS. 5A-5B is compatible with BIS and JavaScript. According to one embodiment, the computer program product may include beginning and ending markers for identification of segments of the computer program product. For example, beginning and ending markers for global system variables are shown on lines 009 and 018 of FIG. 5A, respectively. Additional beginning and ending markers are shown in lines 019, 032, 033, 042 of FIG. 5A and lines 001, 002, 003, 014, 015, and 028-038 of FIG. 5B.

An example of a hybrid data structure at various stages of reformatting is provided in the Computer Program Listing, which is hereby incorporated by reference, under “Exemplar0,” “Exemplar1,” and “Exemplar2.” Exemplar0 illustrates raw input data before formatting for use on a platform. The first character of each line characterizes a purpose: tab lines for section headers, asterisk lines for key names, and leading space lines at the start of a line or consecutive lines. Exemplar1 illustrates the content of Exemplar0 after packaging for use on a specific instance of a platform for a single language (e.g., BIS script). Due to the formatting of Exemplar1, the data may be difficult to read in platforms other than that single platform. Exemplar2 illustrates a new re-packaged and re-formatted data structure encapsulating both code to load inputs and a table of the input values. For example, the value of SvcTitle may be made available to the first script (e.g., a BIS script) through the initial scripted block of code and external subroutines may be used to scan the table to extract the same values with a second script (e.g., a JavaScript) on a second platform. One script on one platform executes script in the new re-packaged data structure to read values from the data structure. A second script may include subroutines external to the data structure in order to read the table values from the data structure.

FIGS. 6A-6E are a computer program product illustrating an exemplary table according to another embodiment of the disclosure. The computer program product includes a table on lines 024 of FIG. 6B to line 044 of FIG. 6C. A compatibility statement is included on line 003 of FIG. 6A. Additionally, a script for execution by BIS is included in lines 004 of FIG. 6A to line 023 of FIG. 6B. The computer program product may be executable by a first platform such as BIS. The table of the computer program product may be compatible with at least a second platform such as JavaScript. For example, the table may be compatible for reading by a JavaScript. According to one embodiment, an include file is included in the computer program product having a script for reading the data from the table and placing the data in an array accessible by the JavaScript. The computer program may further include code to save the table, code to register the table, code to restore the table, and code to remove the table. Program code illustrating usage of the scripts of FIGS. 6A-6E is provided in the Computer Program Listing under “JSSimple” and “BIS10ICESVC.” For example, the “exemplar1” input coding (also provided in the Computer Program Listing) may be usable by the “BIS10ICESVC” script but not usable by the “JSSimple” script. However, the “exemplar2” input coding may be compatible with multiples scripts including the “BIS10ICESVC” and the “JSSimple” scripts as a result of the exemplary format of the “exemplar2” script.

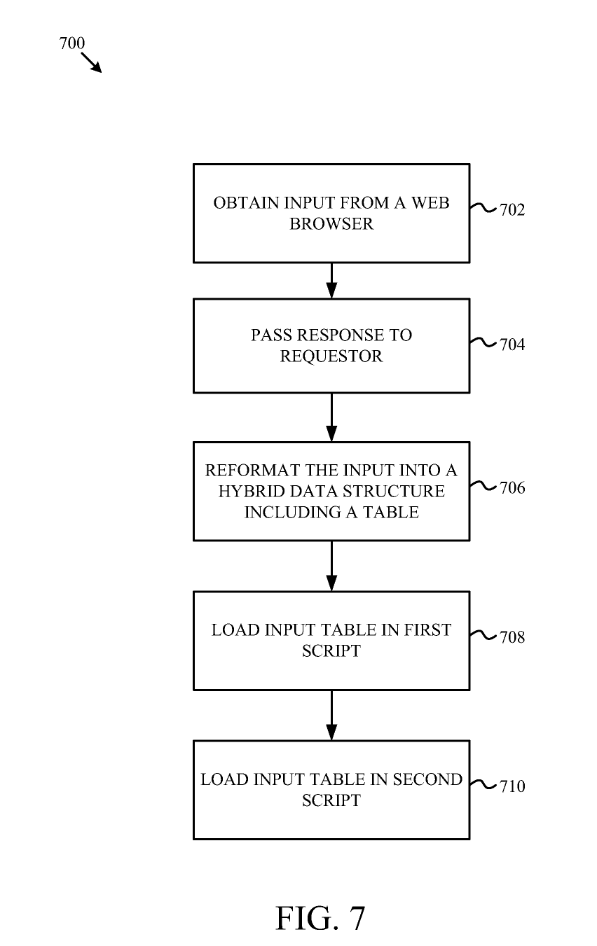

FIG. 7 is a flow chart illustrating a method for processing user input from a web page according to one embodiment of the disclosure. A method 700 begins with obtaining input from a web browser at block 702. The method continues to block 704 passing the response to a requestor. At block 706, the input is reformatted by a reformatter into a hybrid data structure including a table. At block 708, a first script loads input pairs of name and value with an external subroutine such as an include and/or with a load script within the hybrid data structure. At block 710 a second script loads the table from the hybrid data structure. According to one embodiment, processes for a first script loading values at block 708 and processes for a second script loading values at block 710 may execute in parallel. In other embodiments, the first script and the second script of blocks 708 and 710, respectively, execute in sequence.

Additional details regarding data tables accessible by two scripts are disclosed in the attached Appendix A, which is hereby incorporated by reference.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A data structure embodied on a computer readable medium, comprising:
a first script executable by a first platform; and
a table comprising at least one pair of a name and a value, the table consumable by the first script and by a second script executable by a second platform.

2. The data structure of claim 1, further comprising a compatibility statement.

3. The data structure of claim 1, further comprising beginning markers and ending markers for identification of segments of the table.

4. The data structure of claim 1, further comprising at least one of a variable type, a packing option, a variable size, and an array size for each of the at least one pairs of the table.

5. The data structure of claim 1, in which the table is arranged in tab lines.

6. The data structure of claim 1, further comprising code to operate on the table to generate an array from the table accessible by the second script.

7. The data structure of claim 1, in which the second script comprises at least one of code to save the table, code to register the table, code to restore the table, and code to remove the table.

8. The data structure of claim 1, in which the second script is a java script.

9. A method, comprising:
obtaining input from a web browser;
storing the input in a table accessible by a first script of a first platform and a second script of a second platform; and
reading the table by the second script of the second platform.

10. The method of claim 9, in which storing the input in the table comprises storing the table arranged in tab lines.

11. The method of claim 9, further comprising storing a compatibility statement with the table.

12. The method of claim 9, in which the table comprises at least one pair of a name and a value, and in which at least one of a variable type, a packing option, a variable size, and an array size is stored for each of the at least one pairs of the table.

13. The method of claim 9, further comprising storing at least one beginning marker and at least one ending marker in the table.

14. An apparatus, comprising:
at least one processor coupled to a memory, in which the at least one processor is configured:
to obtain input from a web browser;
to store the input in a table accessible by a first script of a first platform and a second script of a second platform; and
to read the table by the second script of the second platform.

15. The apparatus of claim 14, in which the at least one processor is further configured to store the table arranged in tab lines.

16. The apparatus of claim 14, in which the at least one processor is further configured to store a compatibility statement with the table.

17. The apparatus of claim 14, in which the at least one processor is further configured to store pairs of names and values in the table.

18. The apparatus of claim 14, in which the at least one processor is further configured to store at least one beginning marker and at least one ending marker in the table.

19. The apparatus of claim 14, in which the at least one processor is further configured to store the first script with the table.

20. The apparatus of claim 19, in which the at least one processor is further configured to store the second script with the table.
